(19) United States
(12) Patent Application Publication
(10) Pub. No.: US 2016/0077501 A1
(43) Pub. Date: Mar. 17, 2016

(54) WIRELESS SENSOR NETWORK

(71) Applicant: KCF Technologies Incorporated, State College, PA (US)

(72) Inventors: Jacob Joseph Loverich, State College, PA (US); Stephen J. Wenner, Port Matilda, PA (US); Scott David Brown, Rollinsford, NH (US)

(21) Appl. No.: 14/486,266

(22) Filed: Sep. 15, 2014

(51) Int. Cl. G05B 15/02; H04L 29/08

(52) U.S. Cl. CPC G05B 15/02; H04L 67/10

(57) ABSTRACT

A device comprises a processing unit, a network interface configured to enable communications in a network, and a machine-readable medium that stores instructions executable by the processing unit. The instructions are configured to cause the processing unit to receive, from a controller device in the network, information for operating in one or more states associated with collecting data, and to operate in a first state based on the information. Operating in the first state includes controlling a first sensor coupled to the device for collecting first sensor data at a first sampling rate, executing a first trigger, and determining an output of the first trigger. The output of the first trigger is based on the first sensor data. Based on the output of the first trigger, a determination is made whether to remain in the first state, or switch to a different state.

### TECHNICAL FIELD

This disclosure relates to a wireless sensor network.

### BACKGROUND

A wireless sensor network may include a plurality of sensor nodes that are configured to collect sensor data of various types. The wireless sensor network may be used to monitor different processes.

### SUMMARY

This disclosure relates to a wireless sensor network that can be used to monitor complex industrial processes. Individual sensor nodes in the wireless sensor network are programmed with functionality (also referred to as node behavior) that specifies how sensor data is collected by each node. The behavior of an individual sensor node is described as a collection of states and triggers that together comprise a state machine. Each state of the state machine includes processes describing how sensors are sampled and communicated while the sensor node is operating in that state. A trigger provides mechanisms for the associated sensor node to change from one state to another, and thereby change the operation of the sensor node. New state machines can be implemented or existing state machines can be updated, or both, in sensor nodes, thereby dynamically changing the sensor node behavior, while the wireless network is in full operation. Different sensors may be sampled by different state machines and the sensor data collected by the sensor nodes may be varied in type and/or frequency during operation of the wireless sensor network.

In a general aspect, a device comprises a processing unit, a network interface that is configured to enable communications in a network, and a machine-readable medium that stores instructions that are executable by the processing unit. The instructions, when executed, are configured to cause the processing unit to receive, from a controller device in the network and through the network interface, information for operating in one or more states associated with collecting data. The instructions, when executed, are also configured to cause the processing unit to operate in a first state based on the information. Operating in the first state includes performing operations that include controlling a first sensor coupled to the device for collecting first sensor data at a first sampling rate, executing a first trigger, and determining an output of the first trigger. The output of the first trigger is based on the first sensor data. Based on the output of the first trigger, a determination is made whether to remain in the first state, or switch to a different state.

Particular implementations may include one or more of the following features. The instructions may be configured to cause the processing unit to perform operations that comprise determining that the output of the first trigger includes a first value. In response to determining that the output of the first trigger includes a first value, switching to a second state may be performed, wherein switching to the second state may be based on the information received from the controller device. The processing unit may operate in the second state, which may include controlling a second sensor coupled to the device for collecting second sensor data. The second sensor may be configured to collect data of a different type than data collected by the first sensor. The second sensor data may be different from the first sensor data.

The instructions may be configured to cause the processing unit to perform operations that comprise determining that the output of the first trigger includes a second value. In response to determining that the output of the first trigger includes a second value and based on the information received from the controller device, the processing unit may operate in the first state, which may include performing operations comprising controlling the first sensor for collecting first sensor data at a second sampling rate that is different from the first sampling rate.

The instructions may be configured to cause the processing unit to perform operations that comprise executing a second trigger while operating in the first state. The processing unit may determine that an output of the second trigger includes a first value, wherein the output of the second trigger may be based on the first sensor data. In response to determining that the output of the second trigger includes the first value and based on the information received from the controller device, the processing unit may switch to a second state and operate in the second state, which may include controlling a second sensor coupled to the device for collecting second sensor data. The second sensor may be configured to collect data of a different type than data collected by the first sensor. The second sensor data may be different from the first sensor data.

The instructions for executing the first trigger may include instructions that cause the processing unit to perform operations comprising executing the first trigger at a first schedule and with first priority.

The instructions may be configured to cause the processing unit to perform operations comprising receiving, from the controller device and through the network interface, new information for operating in one or more new states associated with collecting data. The processing unit may operate in a third state that is included in the one or more new states based on the new information.

The instructions for receiving the new information for operating in one or more new states may include instructions that are configured to cause the processing unit to perform operations that comprise downloading, from the controller device and through the network interface, information corresponding to the one or more new states. The processing unit may save the information corresponding to the one or more new states and may execute the information corresponding to the one or more new states. The processing unit may operate in the third state in response to executing the information corresponding to the one or more new states.

The instructions for receiving the new information for operating in one or more new states may include instructions that are configured to cause the processing unit to perform operations that comprise retrieving, from memory coupled to the device, information corresponding to the one or more new states that is saved in the memory. The processing unit may execute the information corresponding to the one or more new states. The processing unit may operate in the third state in response to executing the information corresponding to the one or more new states.

In another general aspect, a device includes a processing unit, a network interface configured to enable communications with sensor devices in a network, and a machine-readable medium that stores instructions executable by the processing unit. The instructions, when executed by the processing unit, are configured to cause the processing unit to perform operations that comprise sending, using the network interface and to a sensor device in the network, information for operating in one or more states that include information for collecting data from a first sensor coupled to the sensor device. The processing unit receives, from the sensor device, sensor data collected by the sensor device from the first sensor. The processing unit examines the sensor data received from the sensor device. In response to examining the sensor data received from the sensor device, the processing unit sends, to the sensor device, new information for operating in one or more new states that include information for collecting data from a second sensor coupled to the sensor device. The second sensor is configured to collect data of a different type than data collected by the first sensor.

Particular implementations may include one or more of the following features. The instructions for sending the new information for operating in one or more new states may include instructions that are configured to cause the processing unit to perform operations comprising generating the new information for operating in one or more new states based on examining the sensor data received from the sensor device. The instructions for generating the new information for operating in one or more new states may include instructions that are configured to cause the processing unit to perform operations comprising generating the new information for operating in one or more new states based on examining sensor data received previously. The sensor data received previously may be stored in memory coupled to the device.

The sensor data collected by the sensor device from the first sensor may include sensor data collected at a first sampling rate. The new information for operating in one or more new states may include information for collecting data from the first sensor at a second sampling rate that is different from the first sampling rate.

Implementations of the above techniques include methods, systems, computer program products and computer-readable media. One such system comprises a sensor device that includes a machine-readable medium for storing first instructions that are executable by a first processing unit and, when executed by the first processing unit, are configured to cause the first processing unit to perform one or more of the above described operations. The system also comprises a controller device that includes a machine-readable medium for storing second instructions that are executable by a second processing unit and, when executed by the second processing unit, are configured to cause the second processing unit to perform one or more of the above described operations.

One such method involves performing one or more of the above described operations using a sensor device. The method also may involve performing one or more of the above described operations using a controller device.

One such computer program product is suitably embodied in a non-transitory machine-readable medium that stores instructions executable by one or more processing units. The instructions are configured to cause the one or more processing units to perform one or more of the above described operations. One such computer-readable medium stores instructions that, when executed by a processing unit, are configured to cause the processing unit to perform one or more of the above described operations.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIGS. 1A-1D illustrate an example of a wireless sensor network and its components that implement state-based sensor node behavior.

FIG. 2 illustrates an example sensor node state machine.

FIG. 3 is a flow chart illustrating an example process for the operation of the states and the triggers of a state machine in a sensor node.

FIG. 4 is a flow chart illustrating an example of a state machine implemented by a wireless sensor node for the monitoring of a pump.

FIG. 5 is a flow chart illustrating an example of a process implemented by a sensor node for the transition from one state to another by the execution of triggers.

FIG. 6 is a flow chart illustrating an example of a process for adding a new behavior to a sensor node.

FIG. 7 illustrates an example of a wireless sensor network that includes a collection server with system intelligence.

Like reference symbols in different figures represent like elements.

### DETAILED DESCRIPTION

This disclosure relates to a wireless sensor network. The wireless sensor network can be used to monitor complex industrial processes. In some applications, the implementation of such a wireless sensor network to monitor complex industrial processes may reduce the overall cost of maintenance of the machines involved in the processes. Typically, industrial machines are run until failure occurs, or the machines are replaced well in advance of failure, on a preventative maintenance plan. Through the implementation of improved monitoring of the machines, including more accurate and more frequent assessments, these traditional maintenance practices may be improved. The general concept of more informed maintenance practices is known as Condition Based Maintenance (CBM). A wireless sensor network may enable the implementation of CBM practices because the wireless network has the ability to acquire machine heath data frequently and at a reduced cost.

Traditionally, wireless sensors monitor the health data of machines involved in industrial processes on a periodic schedule. This approach to monitoring machine conditions may yield only a subset of the data that is useful for monitoring the health of an industrial process. Another limitation to the traditional condition monitoring method is that the data acquired may not correspond to a time during which important health behavior of the machine is expressed. In contrast to monitoring on a periodic schedule, continuous monitoring by a traditional implementation of a wireless sensor network may generate large amounts of sensor data that can prove to be problematic on a large-scale wireless monitoring network.

Given the above, it may be useful to provide a wireless sensor network to monitor complex industrial processes that utilizes a sensor state machine model. The sensor state machine enables multiple operating states of the sensors within the wireless sensor network, and supports the continuous monitoring of processes without the consumption of large amounts of resources. Instead of acquiring data only at a scheduled time based on a fixed time schedule, the sensors within the network use a few operating states, to continuously monitor the operational status of machines at a low power. The sensors within the network would switch to a high rate data capture mode when a sensor within the network detects a machine is in a critical operation state.

The state machine model may be a computational model that is built from a set of states and associated triggers. The state machine may consist of a set of pre-built code modules that define states and the triggers to move from state to state. The state machine is configured to include multiple states that are linked by binary triggers. A state is a single behavior or status, and a new state is achieved based on external events, the current state, or a group of previous states, or a suitable combination of these. The transition between the states of the state machine is based on a range of configurable trigger events and the data acquired while in a state. A trigger is an external event or a combination of external events that cause a state to change to another state.

The wireless sensor network may support the reconfiguration of the sensor state machine over time to improve the sensor performance and capability. The state machine may be updated based on the large volumes of sensor data that is acquired during the operation of the sensor system. The data sets acquired can be used to increase the understanding of machine failure and can in turn be used to further sophisticate the state machine design.

The devices, systems and processes described in this disclosure provide a solution that enables cost effective acquisition of high value machine health data. The state machine model employed by the wireless sensor network supports continuous low power monitoring of the operational status of one or more machines involved in an industrial process. At detected critical times, the sensors can acquire high accuracy health data at higher rate time than when in the low power monitoring state. This minimizes the power consumed by the sensor and lowers the overall cost for maintenance of a system.

The devices, systems and processes may also enable a large range of node behaviors to be generated with a small selection of states and triggers, based on the implementation of a state machine model. The implementation of a state machine enables node behavior to be built within the conditions of the state and triggers without completely retesting the firmware code each time a change is made. This reduces the cost of implementing such a wireless network to an industrial process since firmware testing and validation are expensive features of wireless network development.

The devices, systems and processes described in this disclosure enable multiple operating states of a sensor node that can support nearly continuous and complex multi-sensor monitoring without consuming large amounts of resources. Continuous monitoring with a traditional implementation may generate large amounts of sensor data that may detrimentally affect node energy consumption, wireless bandwidth usage, data storage space, and complexity required for data interpretation. Locating intelligence in the form of a state machine at the sensor node as described in this document addresses these issues by enabling the sensor nodes to precisely take useful sensor samples to provide machine monitoring.

To illustrate, rather than only have a sleep state and an acquisition state, which is triggered on a fixed time schedule, the devices, systems and processes described in this disclosure uses a few states in which a low power monitoring is used by a sensor node to detect the operational status of the machine. Upon recognizing a critical machine operation state, the sensor node enters a high fidelity data capture mode. In this way, low-level continuous monitoring of the machine may be performed with low-power consumption, while at critical times important high-accuracy health data is acquired and sent over the wireless communication link to collection servers.

As an example, a pressure sensor used in a cavitating pump to accurately assess the severity and associated damage of the cavitation is generally a high-power-consumption (e.g., 4-20 mA) sensor designed to work at high pressures and temperatures. Because of the high power consumption of the sensor, continuously measuring pressure may severely limit battery life, thereby limiting use of the sensor. With a state machine as described herein, an alternative implementation may be used in which the pump vibration would be measured with a very low power consuming accelerometer. Increases in vibration would indicate the possibility of cavitation. A vibration threshold may be used to trigger acquisition of pressure data over a fixed period of time. In this manner, useful data related to the cavitation pressure variation may be captured and sent over the wireless link, while reducing the sensor power consumption.

A state machine as disclosed herein may include multiple states that are linked by binary triggers, instead of a series of sequential operations. The transition between states may be conditional, based on a range of configurable trigger events including the data that is acquired while in a state.

A state machine as disclosed herein may consist of a set of prebuilt code modules, including states defining node input/output and analysis and triggers to move between states, which may be assembled and configured to form the state machine at the sensor node. A large range of node behaviors may be generated with a small selection of states and triggers, which may enable sophisticated node behavior to be built within the constraints of the states and triggers without retesting firmware code when a change is made to a state machine in a sensor node. This may be useful because firmware testing and validation may be expensive sensor development activity, and also may be prone to failure.

As disclosed herein, a state machine implemented in a sensor node may be reconfigurable over a wireless connection. Reconfiguring the state machine may be useful because the optimal state machine for a sensor node may not be known prior to deploying a sensor system. This is because the indicators of machine failure may be specific to a particular type of machine. With new wireless monitoring capability, large sets of sensor data may be available that enable improved understanding of machine failure, which in turn informs the state machine design. Reconfigurability of the state machine in a sensor node is based on the notion that the data acquired by the sensors may support development of new sensor behavior that improves the fidelity of machine monitoring or saves sensor power consumption, among other improvements. Wirelessly reconfiguring the state machine may be advantageous over hardwiring to reprogram each sensor node because sensor nodes may be in difficult-to-reach areas, and exposing a programming header on a low-cost sensor is undesirable due to increased cost.

An industrial application of the devices, systems and processes described in this disclosure may be the monitoring of a pump in a paper mill. A pump in a paper generation process may be a single point of failure, which may lead to expensive downtime when such a failure happens. Hardwiring a sensor to the pump may be prohibitively expensive, such that a route-based monitoring method is traditionally used in which the pump is periodically monitored, for example, on a monthly cycle. This type of monitoring may only measure slow degradation in the pump over time, which includes bearing and impeller wear. However, the main failure mode of the pump may be starvation, which leads to cavitation and rapid wear and ultimately failure of the pump. This may occur in a matter of hours, and is typically not identified until the pump has completely failed and a complete replacement is needed.

The present invention provides a cost-effective approach for monitoring such a pump for cavitation and providing an indicator to the plant operator to shut down the industrial process and address the pump starvation problem when such a situation arises. A traditional wireless vibration monitoring system, e.g., Emerson's CSI 9420, may acquire a vibration data set few times per day. In contrast, the devices, systems and processes described in this disclosure may use a state machine with three states that describe different operational modes of a sensor node used for monitoring the pump. Using this state machine, the sensor node is normally in a standby mode (state 0). The sensor would periodically switch to a low power finite-duration vibration monitoring mode (state 1) to evaluate the operational status of the pump. If the status of the pump is determined to be actively operational, the sensor would pursue continuous low power monitoring of the pump (state 2); otherwise it would return to state 0. If excessive vibration is detected during continuous low power monitoring, then the sensor would transition to state 3, which is a finite sampling mode where a high-fidelity data set is acquired and sent over the wireless communication link to the plant operator. Upon completing the data set acquisition, the sensor node would return to state 0. In this way, the state machine minimizes the time that the sensor node is drawing high power to collect high-value data that would otherwise be overlooked with a traditional wireless monitoring system.

In the above example, reconfigurabiltiy is useful because it may be difficult to characterize fully the vibration and failure behavior of the pump prior to deploying the sensor node. For example, excessive vibration that triggers the data acquisition could be caused by either cavitation or high pump loads. In this case, the sensor node could record a large number of data sets indicating false positives diagnoses for cavitation, which may lead to expensive and unnecessary process shutdowns. Reconfigurability of the sensor node state enables a simple change to the sensor state machine to be implemented wirelessly to address this problem rather than hardwiring to the sensor for reprogramming the node state machine. The wireless state machine reconfiguration may include, for example, a change to the trigger criteria that only evaluate the high frequency content of the state 2 vibration monitoring, which is specific to cavitation rather than machine loading.

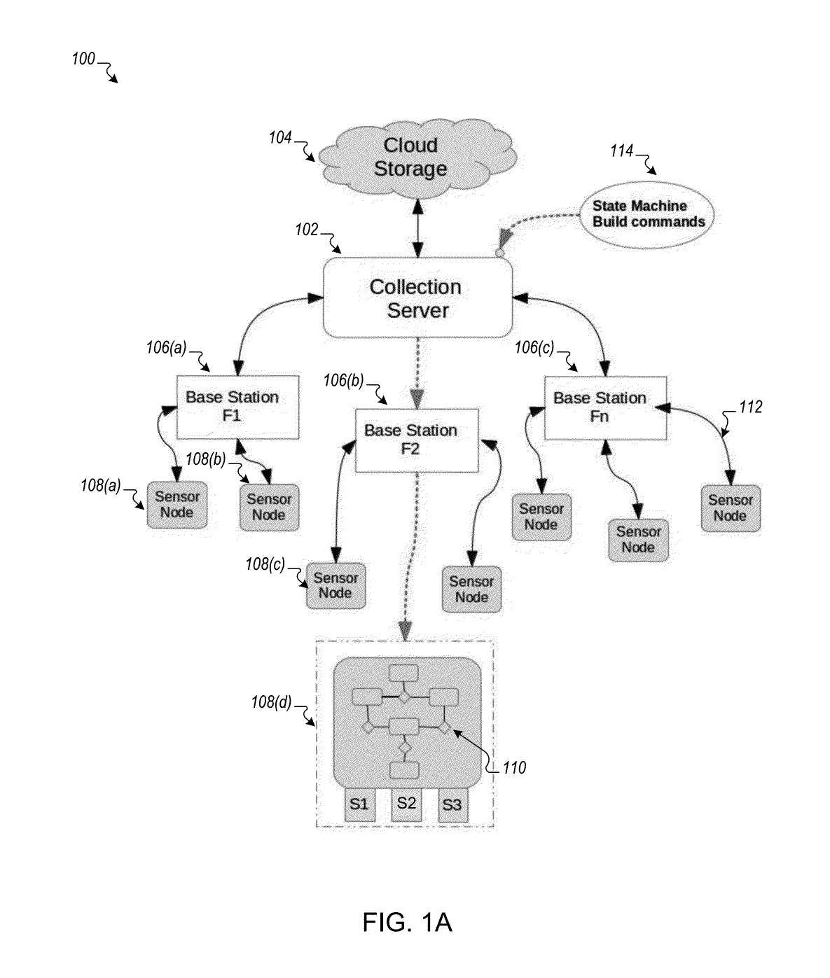

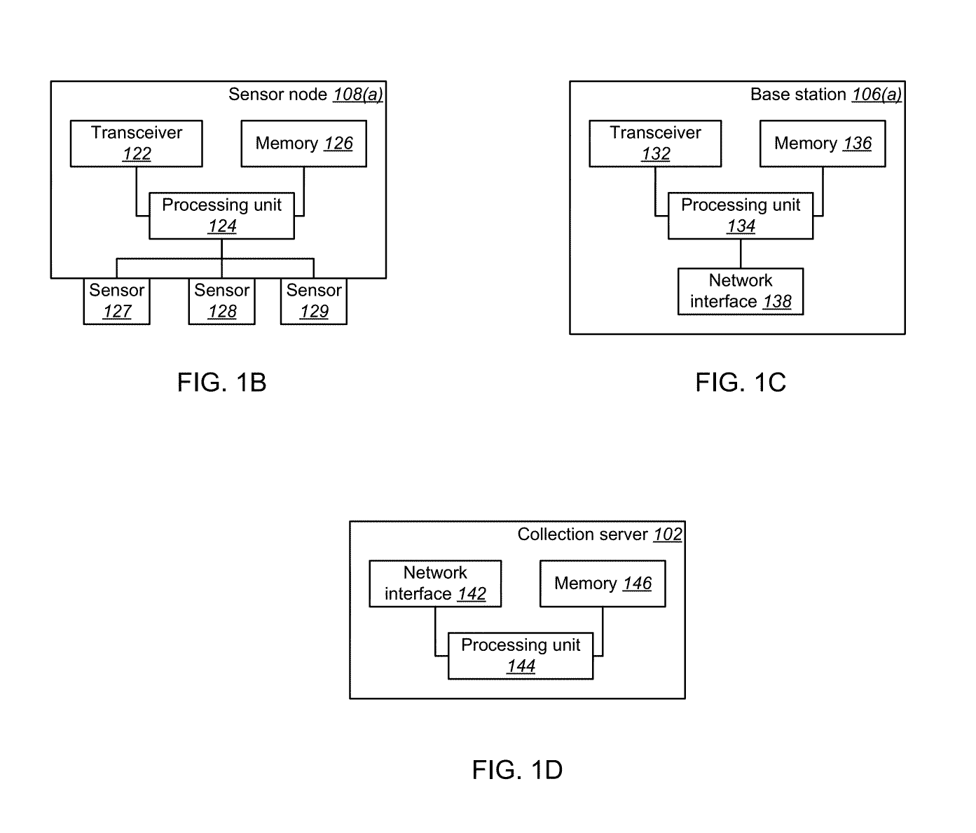

FIGS. 1A-1D illustrate an example of a wireless sensor network 100 and its components that implement state-based sensor node behavior. As shown in FIG. 1A, the wireless sensor network 100 includes one or more sensor nodes, such as nodes 108(a), 108(b), 108(c) and 108 (d) (collectively referred to as sensor nodes 108), one or more base stations 106(a), 106(b) and 106(c) (collectively referred to as base stations 106), and a collection server 102. In some implementations, the collection server 102 may be connected to cloud storage 104.

The sensor nodes 108 are spatially distributed throughout the network. The sensor nodes 108 in the wireless sensor network 100 may be any type of network node or communication node. For example, the one or more nodes 108(a), 108(b), 108(c) and 108(d) may be configured to receive input signals, or to provide output signals, or both. The input signals and/or the output signals may include instructions for operation of the sensor nodes and/or sensor data. The instructions may include state machines describing node states and triggers for the sensor nodes.

FIG. 1B shows components of the sensor node 108(a), which is representative of the one or more sensor nodes 108. Sensor node 108(a) is a processing device that includes, as shown, a transceiver 122 for receiving and/or sending signals. In some implementations, the transceiver 122 may be a wireless network interface, while in other implementations the transceiver 122 may be a wired network interface. The sensor node 108(a) also includes a processing unit 124 for processing instructions and/or data. The processing unit 124 may be a microprocessor or microcontroller, a field-programmable gate array (FPGA), a digital signal processor (DSP), or some other suitable unit that is capable of processing instructions and/or data. The sensor 108(a) also includes memory 126 for storage of the instructions and/or data. The memory 126 may be one of a hard disk, flash memory, read-only memory (ROM), random access memory (RAM), or some suitable combination of these, or some other memory that is capable of storing instructions and/or data.

The sensor 108(a) further includes one or more sensors 127, 128 and 129 for sensing data, e.g., those associated with the monitored machines. For example, the sensors 127, 128, or 129 may be similar to the sensors S1, S2 and S3 included in sensor node 108(d), as shown in FIG. 1A. In some implementations, one or more of the sensors 127, 128 or 129 may be an accelerometer, gyroscope, magnetometer, strain gauge, load cell, temperature sensor, pressure sensor, vibration sensor, infrared (IR) sensor, motion sensor, or any other suitable sensor.

In some implementations, each of the sensor nodes 108 may implement a state machine that describes the operation of the sensor node. For example, as shown in FIG. 1A, the sensor node 108(d) includes state machine 110.

Using such state machine implementations of sensor nodes, the wireless sensor network 100 shown in FIG. 1A can be used for structuring and deploying reconfigurable sensor node behavior in an industrial wireless sensor network. For example, the one or more sensor nodes 108 may be placed within one or more machines involved in an industrial process. The sensor nodes may be connected to one or more electrical or mechanical components of the machines involved in the industrial process. A state machine model may be used for the sensor nodes 108 to monitor the operational status of one or more machines involved in the industrial process by monitoring and collecting, by each sensor node, data corresponding to the operation of the machine associated with the respective sensor node.

Each of the one or more sensor nodes 108 may communicate with one or more of the base stations, such as base station 106(a), 106(b) or 106(c). A sensor node may communicate with a base station over a communications channel. In some implementations, the communications channel includes the wireless radio frequency (RF) channel 112. The one or more sensor nodes 108 may communicate collected sensor data to one of the base stations via the RF channel 112. In other implementations, a different communications channel may be used, which may be a wired or wireless communications channel.

The RF channel 112 may be part of a local area network (LAN), or a wide area network, e.g., the Internet. The network may include one or more wireless RF channels, which are used by the sensor nodes to communicate with the base station 106. Each RF channel 112 may operate at a different frequency and data rate, or all or some of the RF channels may operate at the same frequency and data rate. Each RF channel may have the same bandwidth and be capable of supporting similar data rates, or the RF channels may have different bandwidths and support different data rates. In some implementations, the number of RF channels included in the network may be the same as or greater than the number of sensor nodes in the wireless sensor network, such that each sensor node is able to transmit using a different RF channel. However, in other implementations, the number of RF channels may be less than the number of sensor nodes, such that at least some of the sensor nodes 108 share some of the RF channels for transmission.

Each of the one or more base stations 106 acts as a gateway between the collection server 102 and the one or more sensor nodes 108. FIG. 1C shows the components of base station 106(a), which is representative of the one or more base stations 106. Base station 106(a) is a processing device that includes, as shown, a transceiver 132 for receiving and/or sending communication signals. In some implementations, the transceiver 132 may be a wireless network interface, while in other implementations the transceiver 132 may be a wired network interface. The base station 106(a) also includes a processing unit 134 for processing instructions and/or data. The processing unit 134 may be a microprocessor or microcontroller, a field-programmable gate array (FPGA), a digital signal processor (DSP), or some other suitable unit that is capable of processing instructions and/or data. The base station 106(a) further includes memory 136 for storage of the instructions and/or data. The memory 136 may be one of a hard disk, flash memory, read-only memory (ROM), random access memory (RAM), or some suitable combination of these, or some other memory that is capable of storing instructions and/or data. In addition, the base station 106(a) includes one or more network interfaces 138 to communicate with the sensor nodes 108 or collection server 102, or both. In some implementations, the network interface 138 may be combined with the transceiver 132 as a single network component.

Each base station 106(a), 106(b) or 106(c) may be configured to facilitate bidirectional communication to some or all of the one or more sensor nodes 108. For example, as illustrated in FIG. 1A, base station 106(a) may be in communication with sensor nodes 108(a) and 108(b), while base station 106(b) may communicate with sensor nodes 108(c) and 108(d), among others, and base station 106(c) may communicate with yet other sensor nodes.

The base stations 106 send instructions, including state machines, to the sensor nodes 108 and receive collected sensor data from the sensor nodes. In some implementations, the one or more base stations 106 communicate the sensor data to the collection server 102 immediately upon receipt received from the one or more sensor nodes. In other implementations, the base stations 106 communicate the sensor data to the collection server 102 on a fixed time schedule.

The collection server 102 may include one or more servers that process sensor data collected by the sensor nodes 108, and forwarded to the collection server 102 by the base stations 106. Additionally or alternatively, the collection server 102 may send instructions to the sensor nodes 108 for collecting sensor data.

FIG. 1D shows the components of the collection server 102. As shown, collection server 102 includes a network interface 142 through which the server 102 is connected to the base stations 106, which in turn communicate with the sensor nodes 108. In some implementations, the collection server 102 may include a plurality of network interfaces 142. In some implementations, the network interface 142 may be a wireless network interface, while in other implementations the network interface 142 may be a wired network interface.

The collection server 102 also includes a processing unit 144 for processing instructions and/or data. The processing unit 144 may be a microprocessor or microcontroller, a field-programmable gate array (FPGA), a digital signal processor (DSP), or some other suitable unit that is capable of processing instructions and/or data. The instructions and/or data processed by the collection server 102 may be stored in memory 146, which may be one of a hard disk, flash memory, read-only memory (ROM), random access memory (RAM), or some suitable combination of these, or some other memory that is capable of storing instructions and/or data. In some implementations, the collection server 102 may be configured to store sensor data in the cloud storage 104, or retrieve sensor data from the cloud storage 104, or both. The collection server 102 may communicate with the cloud storage 104 via one or more network connections, e.g, established using the network interface 142.

The sensor nodes within the wireless sensor network may be configured to execute an adaptable state machine. A state machine may be a computational model that is built from a set of states and the transitions associated with each of the states. The state machine controls the behavior of the sensor node. The state machine build commands 114 shown in FIG. 1A may be received by a sensor node 108 from the collection server 102 by way of a base station. The state machine build commands 114 may be communicated to the collection server, the base station, and the sensor node by an RF channel. The state machine model that is executed by the sensor node defines the sensor node behavior. In some implementations, the state machine commands may be programmed and communicated to the sensor node prior to the deployment of a sensor network on an industrial process. In other implementations, the state machine commands can be built and communicated to the sensor node while the node is operational.

As noted previously, a sensor node may be programmed with one or more state machines. The behavior of the sensor node may be switched from one desired behavior to another by switching the state machine commands that are executed by the sensor node. In some implementations, the collection server 102 may communicate the first set of state machine commands to the base station that is in communication with the sensor node, e.g., one of the base stations 106, which in turn communicates the first set of state machine commands to the sensor node, e.g., over RF channel 112. In some examples, the RF channel 112 used by the collection server, the base station and the sensor node is the same, that is, the collection server 102 is transmitting using the same frequency (F) and data rate (R) at which the base station and the sensor node is listening. When the behavior of the sensor node implementing the first state machine is no longer desired, the collection server may communicate a second set of state machine commands to the sensor node.

In some implementations, the state machine commands may be stored at the cloud storage 104. The collection server 102 may retrieve the state machine commands from the cloud storage and communicate to the sensor node via a connected base station. In some implementations, the collection server 102 may be configured to build the state machine commands 114 based on instructions stored in the cloud storage 104, or instruction configured in the collection server 102, or both. In some implementations, the instructions may be configured by an administrator of the wireless sensor network 100, or by an operator of the industrial process (which may be same as the administrator of the wireless sensor network), or by some other suitable entity. The operation of an example sensor node state machine is described in more detail in the following sections.

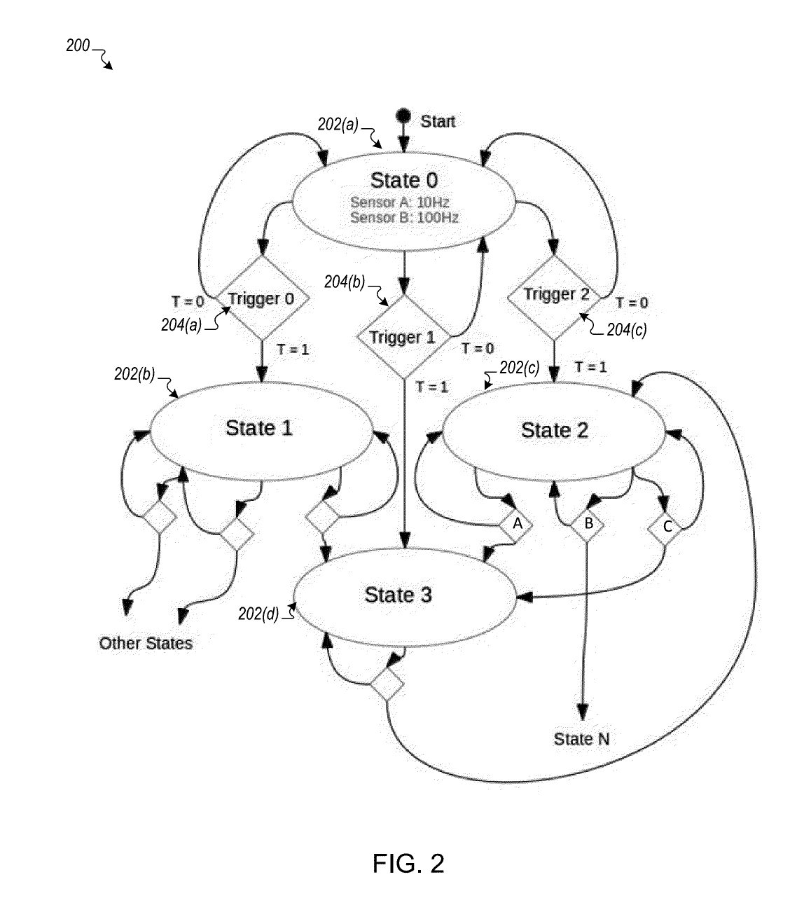

FIG. 2 illustrates an example sensor node state machine 200. The state machine 200 may be executed by one or more of the sensor nodes 108. Accordingly, the following describes the state machine 200 as being implemented in the wireless sensor network 100. However, the state machine 200 may be implemented in other systems or system configurations.

As noted previously, a state machine may include one or more states and one or more triggers. For example, the state machine 200 includes one or more states, such as 202(a), 202(b), 202(c) and 202(d), and one or more triggers, such as 204(a), 204(b) and 204(c).

In some implementations, a state is a singular mode of operation of a sensor node and may be defined by a sensor sampling configuration. For the example illustrated in FIG. 2, the sensor node is in state 202(a) when sensor A is sampled at 10 Hz and sensor B is sampled at 100 Hz. A state may also be defined by a data transmission schedule. For example, a state may be defined as sampling sensor A at 200 Hz and sampling sensor B at 50 Hz, and transmitting the sampled data every 2 seconds. The state sensor sampling rates may be programmed into the state machine model. The state sensor sampling rates may be included in the state machine build commands that are communicated from the collection server 102 to the sensor node. Each of the one or more states included in a state machine may be programmed to include different sensor configurations. For example, the sensor node may be in state 202(b) when sensor A is sampled at 100 Hz and sensor C is sampled at 20 Hz, and in state 202(c) when sensor A is sampled at 200 Hz and sensor C is sampled at 100 Hz.

A trigger is an external event, or a combination of external events that may cause a change from one state to another state. However, in some implementations, depending on the result of the trigger, the sensor node may continue to operate in the same state as before the trigger. For example, an expiration of a time period can act as a trigger event. Another example of a trigger event may include a sensor value exceeding a threshold level. In some implementations, each of the one or more triggers in the state machine 200 acts as a binary classifier. The trigger may facilitate the switch from one state to another if the trigger returns a 1, but there is no change in state if the trigger returns a 0. For example, as shown, when the sensor node is in state 202(a) and trigger 204(a) returns a 0, state 202(a) is maintained, i.e., the sensor node remains in state 202(a). However, when trigger 204(a) returns a 1, the state of the sensor node changes from 202(a) to 202(b).

Each state within a state machine may be assigned one or more triggers. As illustrated in FIG. 2, triggers 202(a), 202(b) and 202(c) are all associated with state 202(a). In some implementations, the triggers assigned to a state may be executed based on a priority. The state machine commands communicated from the collection server to the sensor node may include the trigger priority. For example, the priority of trigger 204(a) may be higher than that of 204(b), which in turn may be higher than that of trigger 204(c). In some implementations, the triggers assigned to a state may be executed on a time schedule. For example, a trigger may cause a state change every two hours. A state may be assigned one or more triggers that transfer operation to the same state using different trigger operations. For example, as illustrated in FIG. 2, when a sensor node is in state 202(c), trigger A may facilitate the state change from 202(c) to 202(d) when trigger A returns a 1, and trigger C may also facilitate the change from state 202(c) to 202(d) when trigger C returns a 1. In this example, the triggers A, B, and C may be executed based on the trigger priority.

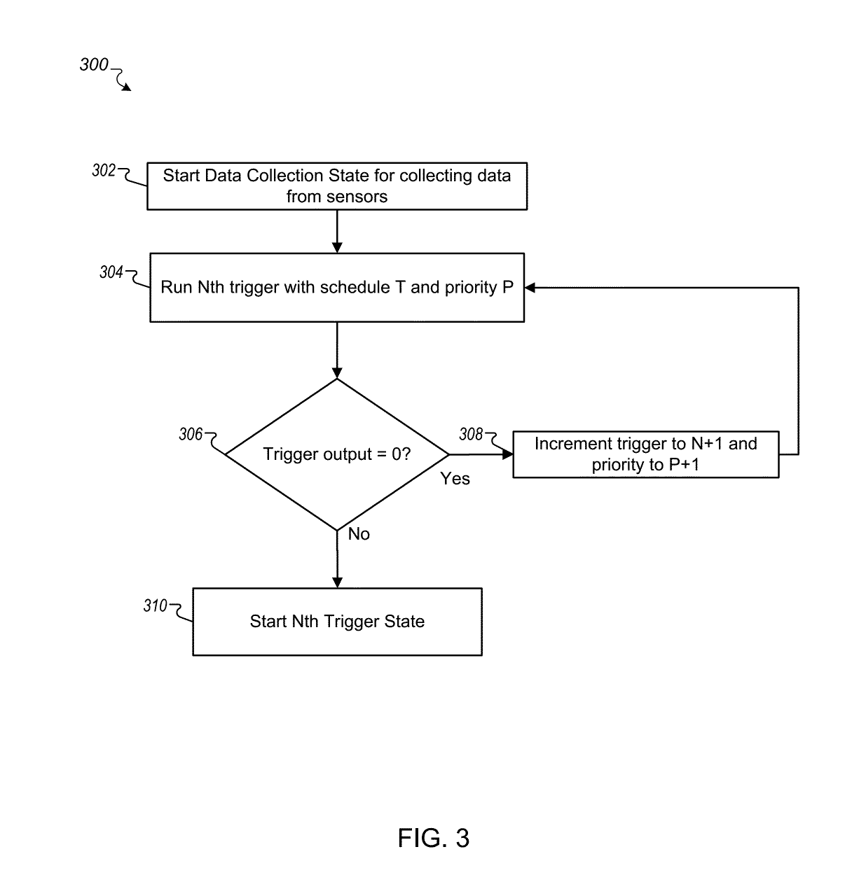

FIG. 3 is a flow chart illustrating an example process 300 for the operation of the states and the triggers of a state machine in a sensor node. The process 300 may be used by a state machine executed by one or more sensor nodes 108. Accordingly, the following describes the process 300 as implemented by the wireless sensor network 100. However, the process 300 may be implemented in other systems or system configurations.

One or more of the sensor nodes 108 may implement the process 300 using the one or more microprocessors that are included in the respective sensor node. The microprocessors may implement the process 300 based on instructions stored in the memory included in the sensor node. The instructions may be sent by the collection server 102, and may include the state machine build commands 114. A sensor node may receive the state machine commands through communication with the collection server via RF channel 112. The state machine commands may be communicated from the collection server 102 to a base station (e.g., one or more of base stations 106) that, in turn, communicates the state machine commands to the sensor node.

At 302, data collection state is started in a sensor node for collecting data from sensors. For example, the sensor node 104(d) operates in the data collection state of the state machine 110 implemented in the sensor. When sensor node 104(d) is in the data collection state, one or more of the sensors S1, S2 and S3 are operated for collecting data.

As noted above, the sensor node may receive the state machine commands from the collection server 102. The state machine commands may be programmed to include the sensor sampling configuration and data transmission schedule for the one or more states within the state machine. The sensor sampling configuration data received may include the sampling rates for each sensor within the sensor node for each state of the state machine. For example, a sensor node, such as 108(d), with three sensors, e.g., S1, S2 and S3, may receive sensor sampling data for a state 0 that specifies the sampling rate for sensor S1 at 20 Hz, the sampling rate for sensor S2 at 100 Hz, and the sampling rate for sensor S3 at 0 Hz. The data transmission schedule may specify the length of time that sensor data should be collected before being transmitted from the sensor node.

In the data collection state, the one or more sensors within the sensor node are activated and begin sampling and transmitting data at the sampling rate specified by the state. The collected data may be transmitted to the base station (e.g., base station 106(b)) via the RF channel 112.

At 304, the Nth trigger is run based on schedule T and priority P. As noted previously, the state machine commands received from the collection server may include the scheduling and priority data for the execution of triggers, where a state may be associated with one or more triggers that are executed based on the scheduling data. For example, the state 202(a) is associated with triggers 204(a), 204(b) and 204(c). The one or more triggers may be executed on a time schedule: trigger 204(a) may be executed at the end of a two-hour period, and 204(b) may be executed at the end of a four-hour period. In some implementations, one or more triggers may be scheduled for execution at the same time. In such cases, the trigger with the highest priority may be executed first. If the trigger with the highest priority does not return a 1 result (i.e., returns a 0 result), the trigger with the second highest priority is run. If a high priority trigger returns a 1, the lower priority triggers do no execute.

At 306, the trigger makes a determination for an output based on inputs. As noted previously, the trigger acts a binary classifier and will output either a 0 or a 1 for all possible inputs. A trigger may be internally generated or may be dependent on incoming sensor data.

When the trigger output is a 0, at 308, the trigger is incremented to N+1 and the priority is incremented to P+1. In such an event, based on the received state machine commands, the trigger with the priority second to the executed trigger may then be executed, for example trigger N+1 that has priority P+1. The state of the sensor node may be maintained as the prior state, e.g., the data collection state. Accordingly, the sensor data may be sampled at the same sample configuration and transmitting data schedule.

However, if the trigger output is a 1, then at 310, the Nth trigger state is started, i.e., there is a change in state of operation of the sensor node. For example, the state may change from the data collection state to the Nth trigger state. The sample configuration and the data transmission schedule for the Nth trigger state may be different from the sample configuration and data transmission schedule of the data collection state. For example, with respect to the sensor node 108(d), the sample rate for sensors S1 and S2 in the data collection state may be 10 Hz and 50 Hz respectively, whereas the sampling rate for sensors S1 and S2 in the Nth trigger state may be 100 Hz and 20 Hz respectively.

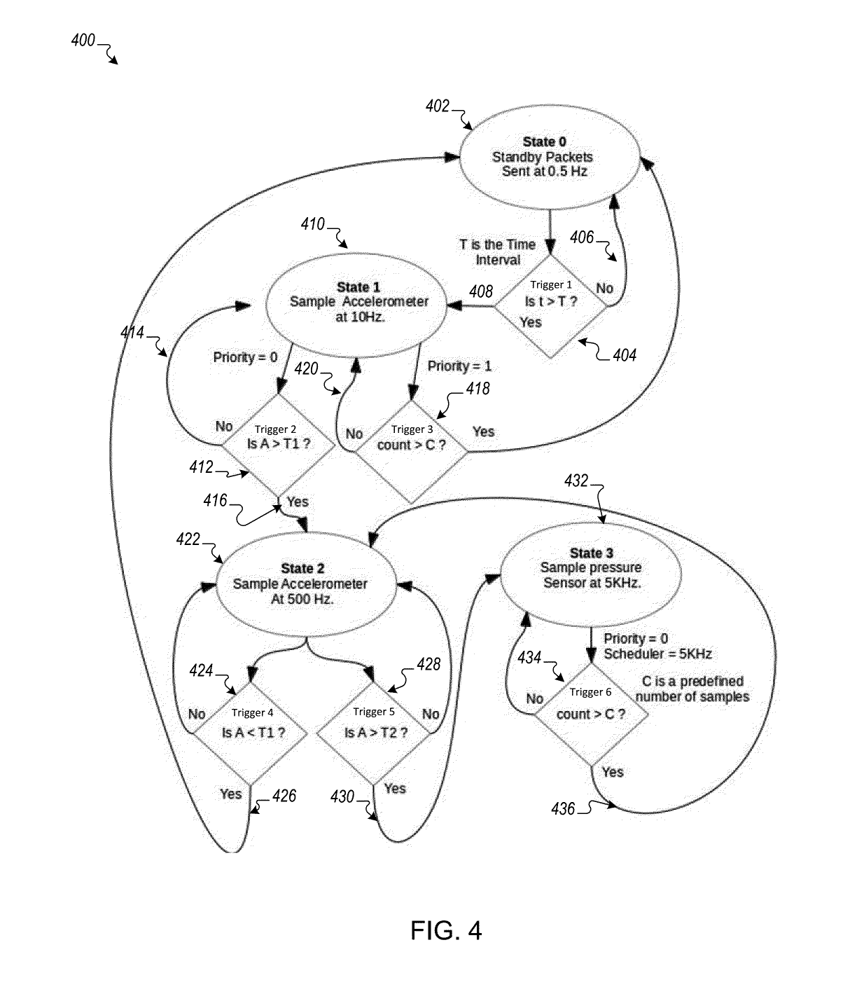

FIG. 4 is a flow chart illustrating an example of a state machine 400 implemented by a wireless sensor node for the monitoring of a pump. The state machine 400 may be used by one or more of the sensors 108 for measuring parameters related to the operation of an industrial pump. Accordingly, the following section describes the state machine 400 as being performed by components of the wireless sensor network 100. However, the state machine 400 may be performed by other systems or system configurations.

In some implementations, the state machine 400 is implemented by one or more processors included in the wireless sensor node that execute the state machine commands received at the sensor node. The state machine commands may be stored in memory associated with sensor node. The state machine commands may be based on instructions that are stored in the cloud storage and sent to the sensor node by the collection server 102 through a base station connected to the sensor node. The state machine commands may be communicated from the collection server to the sensor node over RF link 112.

At 402, the state machine is in state 0. In state 0, the sensor node transmits standby data packets at a rate of 0.5 Hz. In some implementations, the standby data packets do not include any sensor data. The standby data packets are communicated to a base station over an RF channel. A transmitter at the base station receives the standby data packets and communicates the received packets to the collection server. The standby data packets are communicated to the collection server over an RF channel. The RF channel used by the collection server, the base station and the sensor node may be the same. For example, the sensor node 108(d) may send standby data packets to the base station 106(b) over RF channel 112. The base station 106(b) may forward these standby data packets to the collection server 102 over the RF channel 112.

At 404, trigger 1 determines whether timer interval T has expired. Based on the determination, trigger 1 outputs either a 0 or a 1. The determination whether the time interval or period T has expired may be based on the inputs to the trigger. For example, a time may be input to trigger 1 that is less than the timer interval T; in which case the trigger determines that the period T has not expired and accordingly the trigger may output a 0. As shown at 406, when trigger 1 determines that the period T has not expired (i.e., output of the trigger is 0), the state machine stays in state 0. However, when the time input to trigger 1 is greater than the time interval T, the trigger determines that the period T has expired and accordingly the trigger may output a 1. In this case, as shown at 408, the state machine enters state 1.

At 410, the state machine is in state 1, in which a sensor controlled by the sensor node samples an accelerometer at 10 Hz. In some implementations, the sampled data may be transmitted to the base station connected to the sensor node over an RF link, and subsequently forwarded by the base station to the collection server.

As shown, there are two triggers associated with state 1, namely trigger 2 and trigger 3. The two triggers are executed based on trigger priority, which may be programmed into the state machine build commands for the state machine. Trigger 2 may be executed based on priority 0, while trigger 3 is executed with priority 1, where priority 0 is higher the priority 1 in the execution order. At 412, trigger 2, with the higher priority 0, compares the sampled data A from the accelerometer to a known threshold value T1. The sampled data A and the threshold T1 may be provided as an input to trigger 2 by state 1.

If the result of the comparison indicates that A is less than T1, then the state machine stays in state 1, as shown by 414 (i.e., the output of trigger 2 is 0). The trigger with the lower priority, trigger 3, is executed when trigger 2 does not output a 1. At 418, trigger 3 compares a count of the number of accelerometer samples to a specified threshold C. The count of the number of accelerometer samples and the threshold C may be provided as an input to trigger 3 by state 1.

If trigger 3 determines that the count of the accelerometer samples is less than the threshold C, then the state machine stays in state 1 (i.e., the output of trigger 3 is 0), as shown at 420. However, if trigger 3 determines that the count of the accelerometer samples is greater than C (i.e., the output of trigger 3 is 1), then the state machine enters state 0.

Returning to trigger 1, if the sampled data A is greater than the threshold T1 (i.e., the output of the trigger is 1), then at 416 the state machine enters state 2. At 422, the state machine is in state 2 and the sensor node operates one or more sensors to sample the accelerometer at 500 Hz. The sampling rate of the accelerometer in state 2 is higher than the sampling rate of the accelerometer in state 1. In some examples, the accelerometer may be sampled in a continuous mode. In continuous mode, the data sampled from the accelerometer is buffered and packaged. The packaged accelerometer data is communicated to the base station over an RF link, e.g., RF link 112.

At 424, the trigger 4 determines whether the sampled accelerometer data A is below the threshold T1. The sampled data A and the threshold T1 may be provided as an input to trigger 4 by state 2. The state machine enters state 0 at 426 if trigger 4 determines that A is less than T1.

At 428, trigger 5 determines whether the accelerometer data A exceeds a known second threshold T2. The sampled data A and the threshold T2 may be provided as an input to trigger 5 by state 2. If trigger 5 determines that A is greater than the threshold T2, then at 430, the state machine enters state 3.

At 432, the state machine is in state 3. While in state 3, sensor node operates a pressure sensor to sample pressure date of the machine at 5 KHz. At 434, trigger 6 determines whether a count of data samples from the pressure sensor is greater than a predefined number C of samples. The output of the trigger is a 1 when a number of samples greater than C are acquired. Accordingly, if the count of data samples is greater than C, then the trigger output is 1 and the state machine enters state 2 at 436.

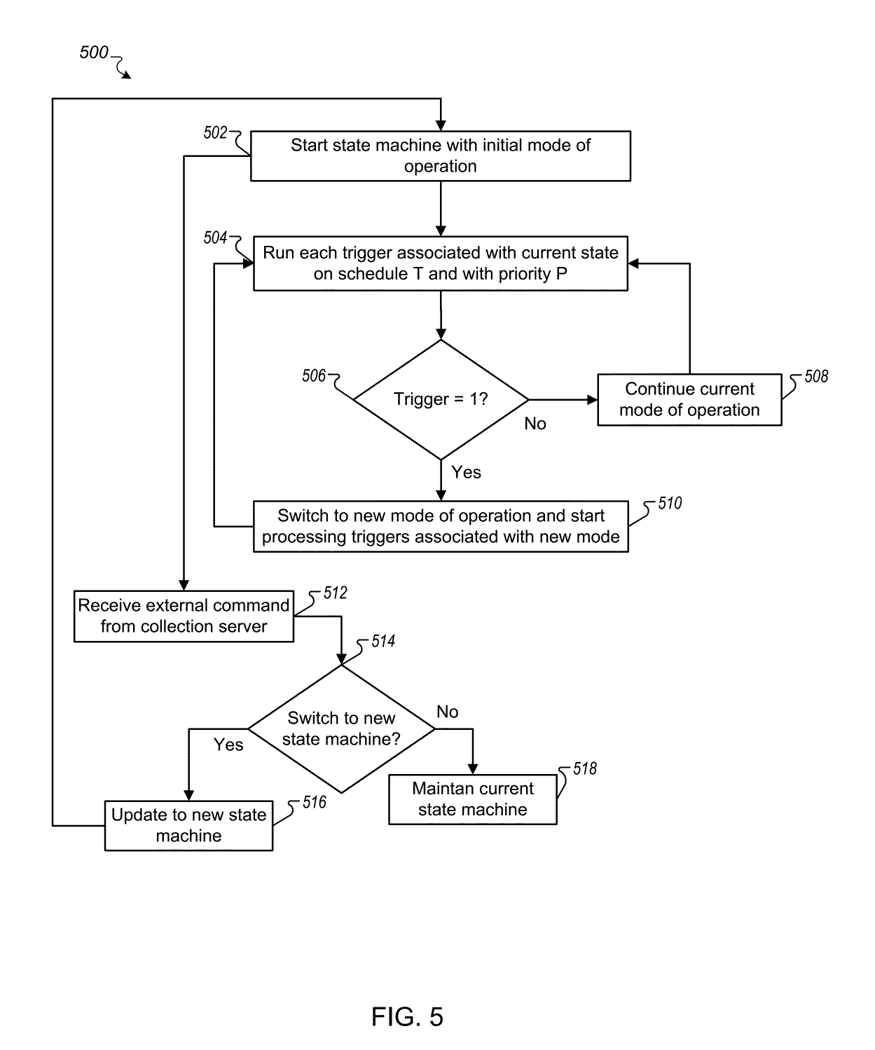

FIG. 5 is a flow chart illustrating an example of a process 500 implemented by a sensor node for the transition from one state to another by the execution of triggers. The process 500 may be used for the execution of a set of state machine commands by one or more of the sensor nodes 108. For example, the sensor nodes 108 within the wireless sensor network 100 may be configured to execute an adaptable state machine, which may be a computational model that is built from a set of state conditions and the transitions that are associated with each of the states. As noted previously, the state machine commands may be preprogrammed into the sensor nodes. The collection server 102 may communicate the state machine commands to a base station, e.g., one or more of the base stations 106, which forwards the state machine commands to one or more sensor nodes, e.g., one or more of sensor nodes 108 that are connected to the respective base station(s). A wireless sensor network that utilizes such a state machine model may be utilized to monitor complex industrial processes. The state machine executed by a sensor node based on the process 500 may enable multiple operating states of sensors associated with the sensor node, and may support the continuous monitoring of industrial processes without the consumption of large amounts of resources. Accordingly, the following section describes the process 500 as being performed by components of the wireless sensor network 100. However, the process 500 may be performed by other systems or system configurations.

At 502, the state machine is started with an initial mode of operation. For example, the sensors within the sensor mode managed by the state machine begin to sample data at the rates and conditions specified by the state machine commands. In this context, the mode of operation refers to a state in the state machine used by the sensor node. In some implementations, the initial state of operation may be state 202(a). For example, with the sensor node implementing the state machine being in an initial state 0, sensor A may sample data at 10 Hz and sensor B may sample data at 100 Hz. In some implementations, the sampling rate for the initial mode of operation may be the lowest sampling rate for the one or more modes of operation. For example, sensor A may be configured to sample at 10 Hz in state 0, but may be configured to sample at 100 Hz in state 1. The respective sensor node may buffer, package, and communicate the sampled sensor data to a base station associated with the sensor node. The data may be communicated via an RF link.

At 504, the state machine runs each trigger associated with the current state on schedule T and with priority P. As noted previously, the execution of triggers may be on a time schedule, for example, a trigger T1 may be executed every thirty minutes and a trigger T2 may be executed every ten minutes. In some implementations, one or more triggers are associated with one state. In such implementations, the one or more triggers associated with the state may be executed based on a priority schedule. For example, trigger A may have a higher priority than trigger B, so trigger A is executed first. If trigger A is executed and the output is not a 1 (i.e., the output does not lead to a change in state) then the second priority trigger B is executed. The state machine commands communicated to the sensor node includes the schedule and priority settings for the one or more triggers included in the state machine. In some implementations, the schedule and priority settings for the one or more triggers may be pre-programmed and communicated to the sensor nodes prior to the implementation of the state machine. In other implementations, the schedule and priority setting for the one or more triggers may be communicated to the sensor nodes after the initial implementation of the state machine.

At 506, the trigger that is executed checks whether the output of the trigger is 1. As noted previously, in some implementations a trigger is a binary classifier that will output 0 or 1 based on the inputs to the trigger. In some implementations, a trigger may be a simple trigger, where the input value is a single value. Examples of simple triggers may include a simple counter that counts the number of samples and compares the number to a set total count value, a digital GPIO line transition, the expiration of a time interval, and monitoring a single sensor output for a certain value that is greater or lesser than a threshold.

In some implementations, triggers may be time complex or spatially complex. Time complex triggers monitor multiple events in time, and cause a state transition when certain events occur in a time order. The order of the occurrence of the conditions within a time complex trigger may determine whether to cause the state transition. A time complex trigger may include two simple triggers with a second condition that is executed only after the first condition has occurred. For example, a time complex trigger may first determine whether data sampled by a sensor exceeds a certain threshold; if the data exceeds the threshold, then the time complex trigger may check whether a count of samples of the data exceed a predetermined count value. If the data sampled by the sensor exceeds the threshold, followed by the sample count exceeding the predetermined count value, then the trigger may output 1, leading to state transition to a different state. Another example of a time complex trigger includes a trigger that transitions to a different state after data sampled by a first sensor exceeds a first threshold and the data sampled by a second sensor exceeds a second threshold.

Spatially complex triggers monitor multiple events that occur at the same time. Spatially complex triggers may be represented by one or more forms, such as statistical classifiers, linear classifiers, Bayesian classifiers, neural networks, support vector machines, among others.

The output of the trigger, either a time complex trigger or a spatially complex trigger, determines if the state machine will remain in the same state or switch to a different state. If, upon checking the output at 506, the trigger determines that the output is 0, then at 508 the state machine stays in the same state. In such cases, the state machine continues in the current mode of operation, and there is no change in sampling rates of sensor data. The state machine will remain in the current state until another trigger is executed based on the schedule and priority data.

However, if the trigger determines that the output is 1 at 506, then the state machine switches to a new mode of operation and starts processing triggers associated with the new mode at 510. For example, the sensor node transitions to a different state of the state machine and performs the operations that are described in the transitioned state. In some implementations, the sampling rates of sensors in the new state, i.e., the new mode of operation of the sensor node, may be different from the sampling rates of sensors in the previous state, i.e., the prior mode of operations of the sensor node. Accordingly, a sensor node may be configured to modify dynamically that type of data that is sampled based on results of prior sensing. In this context, the result of the prior sensing or sampling refers to the sensor node transitioning to a different state due to a trigger output of 1 based on the trigger input(s) that may include results of data sampling in the prior state associated with the trigger.

In some implementations, when the sensor node transitions to a different state, the sensor node may activate one or more sensors that are different from the sensors used in the previous state. For example, the sensor node 108(d) may sample data using sensors S1 and S2 in state 0. However, when the sensor node 108(d) transitions to state 1 based on triggers associated with state 0, the sensors S2 and S3 may be activated to sample data. In this manner, a sensor node may be configured to modify dynamically the type of data that is sampled based on results of prior sensing using other sensors.

As noted previously, new state machine build commands may be downloaded to the sensor node. The new state machine build commands may be sent by the collection server (e.g., 102) based on the sampled sensor data that is transferred from the sensor node to the collection server via a connected base station. In some implementations, the new state machine build commands may include instructions for operating sensors that are not used in the prior state machine. For example, a first state machine implemented by sensor node 108(d) may operate sensors S1 and S2. A second state machine that is downloaded to the sensor node 108(d) based on the data sampled by S1 and S2 may include commands for operating sensor S3. In this manner also, a sensor node may be configured to modify dynamically the type of sensor that is operated and accordingly the type of data that is sampled based on results of prior sensing using other sensors.

In some implementations, the one or more states of a state machine implemented by a wireless sensor network have one or more of several operational modes, which may include the standby mode, the finite sampling mode, and the continuous sampling mode, among others. In the standby mode, the sensor node transmits standby packets to a base station at a periodic interval. In some implementations, the interval may be programmable, e.g., by the wireless sensor network administrator or the industrial machine operator. In some implementations, data is not collected by the sensors when the sensor node is in standby mode, and the standby packets do not include any sampled data information.

The standby data packets are received by the base station, e.g., one of the base stations 106, and may be communicated by the base station to the collection server, e.g., 102. The standby data packets may be communicated over an RF link, e.g., RF link 112. The standby mode allows the sensor nodes within the wireless network to maintain connectivity to the network while in a low power state. A state that uses the standby mode may act as a default state for the state machine implementation in the sensor node. Other states within the state machine may have triggers that cause a state change back to the default state such that sensor node goes to the standby mode. The triggers associated with the standby mode state may be simple triggers, for example, counting the number of standby packets transmitted, and waiting for a time interval to expire.

When the sensor node operates in a finite sampling mode state, the sensors in the sensor node are operated to collect a finite number of data points. In some implementations, the sampling rate for the sensors in the finite sampling mode may be higher than the sampling rate of the sensors in the any other operating mode. The collected data from the sensors may be communicated to a connected base station via an RF data link. In some implementations, the finite sampling mode may be used when the rate of data collection by the sensors is faster than the rate of communication with the base station via the RF data link. In some implementations, the finite sampling mode may be used when a predetermined number of data points used for switching to a different mode of operation. For example, the state machine may be in the finite sampling mode when a temperature reading is used to determine the next mode of operation. One or more triggers can determine when the state machine should switch from a finite sampling mode state to another state implementing a different mode of operation.

In the continuous sampling mode, the sensors in the sensor node continuously sample data. The sensor node buffers the sampled data, and communicates packaged sample data to a connected base station via an RF link. The base station may forward the received data to a collection server. In some implementations, in the continuous sampling mode the sensor node packages and transmits the sampled data at a rate that is consistent with the rate at which the data is collected. This feature makes the continuous sampling mode a sustainable mode for data sensing. The data packets transmitted when the state machine is in the continuous sampling mode may be different sizes. In some implementations, the RF link is activated when the payload of a data packet is filled with sampled data. The RF link then transmits the data packet over the activated RF link. Accordingly, the RF link may be activated in periodic bursts, where the period may be based on the time required to fill the payload of a data packet.

At 512, the sensor node receives an external command from the collection server. The command may be received via an RF link from a base station, e.g., one of the base stations 106, which acts as a gateway between the collection server, e.g., 102, and the sensor node, e.g., one of the sensor nodes 108. The received commands may include a new set of state machine build commands that facilitates the implementation of a new state machine in the sensor node. As noted previously, in some implementations, one or more state machine commands may be stored in memory at the cloud storage, e.g., 104, associated with the collection server, e.g., 102. In these implementations, the state machine commands may be communicated from the cloud storage to the collection server via an RF link, e.g., RF link 112. In other implementations, the wireless sensor network may include a software interface that allows a user to build and deploy a state machine model by implementing one or more states, or one or more triggers, or both, at a time. In such implementations, the software interface may include one or more of the following commands and/or parameters, among other commands and/or parameters.
stm_createStateMachine(void)—Creates a new state machine and returns the state machine ID. This ID should be returned in a message that gives the Collection Server a way to address the state machine.
stm_addState(StateMachineId, StateId, stateType, stateArgs, numberOfRuns)—
stm_getStateMachineId( )—Obtains the identifier for the state machine, which may be an integer.
StateId—Identifies the state with an integer greater than zero.
stateType—is the mode of operation (CM, FM, SBM)
stateArgs are the mode of operation parameters.
numberOfRuns—For FM, if this parameter is greater than 1, the state will run numberOfRuns times before it checks for a state transition, if there is no state transition, the state machine will go to the default 0 state.
stm_addTransition(StateMachineId, StateId, transitionFcnIndex, transitionArgs, Priority, finalStateId)
StateMachineId—Identifies the state machine with an integer, this allows multiple state machines in a system.
transitionFcnIndex—Index into a transition function table, if the state will naturally end, such as with FM this index should be set to 0. The 0th transition function is the NULL function. In CM, this could point to other functions that actually look at data, time or an externally-set general-purpose input/output (GPIO) pin to cause a state change.
Priority—This determines the priority of the transition function execution. Each state could have a number of transition functions that cause the state to exit to unique other states. The functions are executed in priority order and once a transition function evaluates to true, no further transition functions are executed.
finalStateId—If the transition function evaluates to true, the state machine moves to this state.
stm_runStateMachine(StateMachineId, startStateId)—Starts the state machine running with the starting state, startStateId.
stm_stopStateMachine(StateMachineId)—Stops the state machine.

At 514, the sensor node determines whether to switch to the new state machine. For example, the sensor node determines whether to update the state machine implemented by the node using the external commands received from the collection server, or to maintain the current behavior of the node under the currently-implemented state machine.

If the sensor node determines to switch to the new state machine, then at 516, the sensor node updates to the new state machine. In such implementations, the sensor node reconfigures to implement the new state machine and begins to operate under the commands of the new machine state. The new state machine may start operating at the initial operating mode as described with reference to 502. The new state machine may include commands for a different number of states, and triggers with different priorities and time schedules than the previous state machine. On the other hand, if the sensor node determines not to switch to the new state machine, then at 518, the sensor node maintains the current state machine and accordingly maintains the current behavior defined by the current state machine.

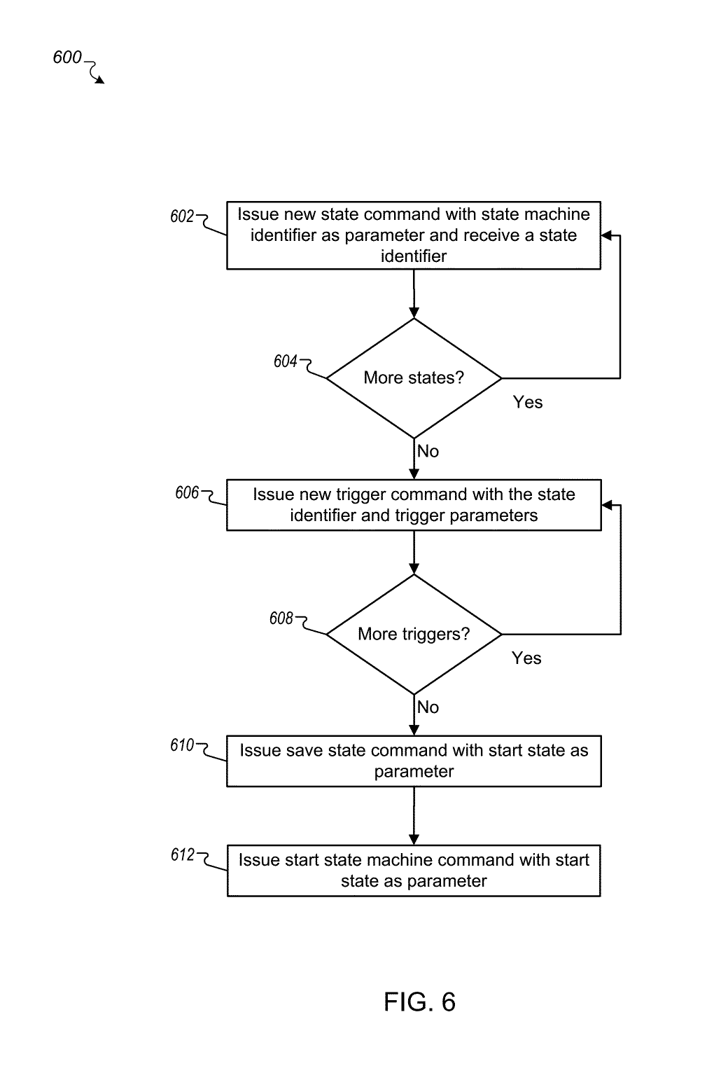

FIG. 6 is a flow chart illustrating an example of a process 600 for adding a new behavior to a sensor node. The process 600 may be used to update the state machine implemented by a sensor node, e.g., one of the sensor nodes 108, while the sensor node is operational. Accordingly, the following section describes the process 600 as being performed by components of the wireless sensor network 100. However, the process 600 may be performed by other systems or system configurations.

In some implementations, the process 600 is implemented using one or more processors included in a server that executes instructions for building a state machine to be used by a sensor node. In some implementations, the server may be the collection server 102 and the instructions may be stored in memory associated with collection server. In some implementations, the instructions may be configured by a user, e.g., an administrator of the wireless sensor network or the industrial machinery/process using the wireless sensor network. The collection server may execute the process 600 to send commands to one or more sensor nodes, e.g., one of the sensor nodes 108, to build a state machine for execution by the sensor node(s). The commands may be sent to the sensor node through a base station, e.g., one of the base stations 106, which is connected to the sensor node. The state machine commands may be communicated from the collection server to the sensor node over RF link 112.

At 602, a new state command is issued with state machine identifier (SMID) as parameter and a state machine identifier is received. For example, the collection server may issue a state command to build a state machine. The collection server may specify an SMID for the state machine as a parameter for the command. The state machine identifier may be a unique identifier that is used to identify the state and the associated state commands. In some implementations, the SMID may be expressed as an integer. The state commands may include the sensor sampling rates and the data transmission schedule for the new state(s) described by the commands. A sensor node receiving the state command may execute the command to build the state machine that includes a start state with an associated state identifier, which is returned upon execution of the state command. The state machine is then populated using a set of commands that create individual states. The collection server may keep track of the state identifiers (e.g., the user interfacing with the collection server may track the state identifiers) so that the triggers may be associated with the proper states when the triggers are created.

At 604, a determination is made whether to include more states in the new state machine. If the collection server determines to add another state to the state machine, the collection server returns to 602 and issues a new state command with the SMID as a parameter. Based on the new state command, the sensor node creates a new state and associates the new state with the newly-created state machine using the SMID parameter. 602 and 604 are repeated until all the desired states of the new state machine are added.

When no further states are to be added to the state machine, then at 606 a new trigger command is issued with the state identifier and trigger parameters. The trigger parameters may include sample inputs, threshold levels, sample counts and any other suitable parameters that act as triggers. The sensor node creates a trigger using the new trigger command, and associates the trigger with the state that is identified by the state identifier provided with the trigger command.

At 608, a determination is made whether to add more triggers to the newly added state. If more triggers are to be added, a new trigger command with the associated state identifier and trigger parameters are issued at 606, and the process repeats as described above. On the other hand, if all the triggers are populated and there are no more triggers to be added, then at 610 a save state command is issued with start state as a parameter. Based on the save state command, the sensor node saves the newly-created state machine to local memory. The sensor node saves the SMID associated with the saved state, along with information identifying the start state for the state machine.

At 612, a start state machine command is issued with start state as a parameter. For example, the collection server sends a start command to the sensor node to implement the state machine. Based on the start state machine command, the sensor node replaces the previous state machine, if any, with the newly-created state machine and accordingly updates the node behavior. The sensor node initially operates in the start state of the state machine that is provided as a parameter for the start command, and operates in a mode that is specified by the start state.

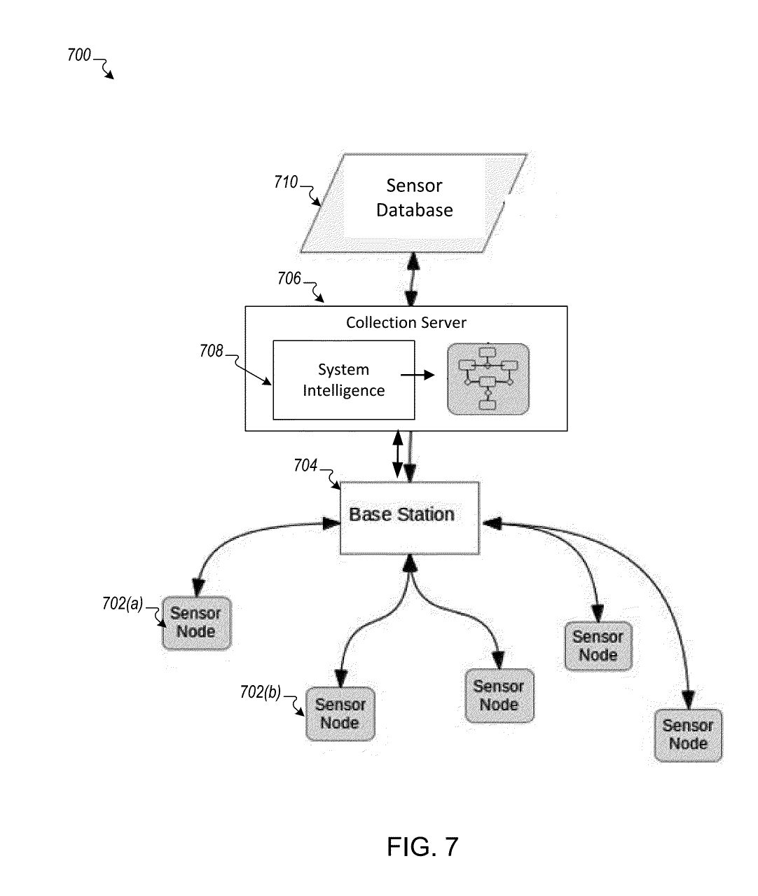

FIG. 7 illustrates an example of a wireless sensor network 700 that includes a collection server with system intelligence. The wireless sensor network 700 may be used for monitoring the performance and/or condition of one or more industrial processes or industrial machinery. In some implementations, the wireless sensor network 700 may be similar to the wireless sensor network 100. In some implementations, the system intelligence in the collection server may be used for various purposes, e.g., to analyze sensor data corresponding to the monitored processes or machinery that is received from one or more sensor nodes, to create a new state machine for the sensor nodes, deploy a new state machine while the sensor network is operational, or some other suitable function.

The wireless sensor network 700 includes one or more sensor nodes such as 702(a) and 702(b) (collectively referred to as sensor nodes 702), a base station 704, a collection server 706 with system intelligence 708, and a sensor database 710.

Each of the sensor nodes 702 may be a processing device with network or communication capabilities. A sensor node may include a wireless transceiver, a processing unit and one or more sensors. Each sensor node may be configured to sense or sample data associated with physical phenomena using one or more sensors included in the node, and providing an output signal with the sampled data. In some implementations, the one or more sensors included in the sensor nodes 702 may include sensors such as accelerometers, gyroscopes, magnetometers, strain gauges, load cells, temperature sensors, pressure sensors, or any other suitable sensor. In some implementations, the sensor nodes 702 may be same as the sensor nodes 108.

The sensor data collected at each of the one or more sensor nodes 702 may be packaged and communicated as data packets to the base station 704 over an RF link. In some implementations, the data packets of sensor data may vary in length.

The base station 702 may act as a gateway between the sensor nodes 702 and the collection server 706. The base station 704 may include transceivers for receiving the sensor data and forwarding the received data to the collection server 706. In some implementations, the base station 704 may be similar to one of the base stations 106.

The collection server 706 may store the collected sensor data at the sensor database 710. The system intelligence 708 at the collection server may analyze the collected sensor data. The sensor data may include data collected from one or more sensor nodes within the wireless sensor network 700 over a period of time. In some implementations, the collection server 706 may be same as the collection server 102. The sensor database 710 may be same as memory coupled to the collection server 102, or it may be similar to the cloud storage 104.

The system intelligence 708 at the collection server may be a software application that is programmed to facilitate the analysis of the collected sensor data. The system intelligence may analyze the sensor data stored at the sensor database 710. The system intelligence 708 may use the large data sets of sensor data to increase the understanding of machine failure of one or more machines monitored by the sensor nodes 702.

The sensor data may be used to optimize or update the state machine executed at the sensor nodes for monitoring the industrial machinery or processes. The system intelligence may be used to automatically create a new state machine. The collection server may communicate the new machine state commands to the sensor nodes, e.g., as described with respect to the process 600. The new state machine commands may be communicated by an RF link to a base station, e.g., 704, connected to the target sensor node(s), e.g., one or more of sensor nodes 702. The base station may forward the state machine commands to the target sensor nodes.

The sensor node(s) may implement and execute the new state machine based on the state machine commands received from the base station while the one or more machines that are monitored are operational. In some implementations, the new state machine created by the system intelligence may be communicated to and executed by every sensor node within the wireless network. In other implementations, the new state machine created by the system intelligence may be communicated to a subset of the sensor nodes in the wireless network.

The disclosed and other examples may be implemented as one or more computer program products, i.e., one or more modules of computer program instructions encoded on a computer readable medium for execution by, or to control the operation of, data processing apparatus. The implementations can include single or distributed processing of algorithms. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory, or a random access memory, or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. For example, a communications channel may include the Web, where a user may interact with an interaction site via a webpage generated dynamically according to the interaction flow. As another example, a communications channel may include a smart phone application, where a user may interact with an interaction site by starting a smart phone application, and the smart phone application then contacts the interaction site and provides a communications interface between the user and the interaction site. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A device comprising:
a processing unit;
a network interface configured to enable communications in a network; and
a machine-readable medium storing instructions that are executable by the processing unit, and when executed configured to cause the processing unit to perform operations comprising:
receiving, from a controller device in the network and through the network interface, information for operating in one or more states associated with collecting data;
operating in a first state based on the information, wherein operating in the first state includes operations comprising:
controlling a first sensor coupled to the device for collecting first sensor data at a first sampling rate;
executing a first trigger;
determining an output of the first trigger, wherein the output of the first trigger is based on the first sensor data; and
based on the output of the first trigger, determining whether to remain in the first state, or switch to a different state.

2. The device of claim 1, wherein the instructions are configured to cause the processing unit to perform operations comprising:
determining that the output of the first trigger includes a first value;
in response to determining that the output of the first trigger includes a first value, switching to a second state, wherein switching to the second state is based on the information received from the controller device; and
operating in the second state, which includes controlling a second sensor coupled to the device for collecting second sensor data, the second sensor being configured to collect data of a different type than data collected by the first sensor, the second sensor data being different from the first sensor data.

3. The device of claim 1, wherein the instructions are configured to cause the processing unit to perform operations comprising:
determining that the output of the first trigger includes a second value; and
in response to determining that the output of the first trigger includes a second value and based on the information received from the controller device, operating in the first state, including performing operations comprising controlling the first sensor for collecting first sensor data at a second sampling rate that is different from the first sampling rate.

4. The device of claim 3, wherein the instructions are configured to cause the processing unit to perform operations comprising:
executing a second trigger while operating in the first state;
determining that an output of the second trigger includes a first value, wherein the output of the second trigger is based on the first sensor data;
in response to determining that the output of the second trigger includes the first value and based on the information received from the controller device, switching to a second state; and
operating in the second state, which includes controlling a second sensor coupled to the device for collecting second sensor data, the second sensor being configured to collect data of a different type than data collected by the first sensor, the second sensor data being different from the first sensor data.

5. The device of claim 1, wherein the instructions for executing the first trigger include instructions that cause the processing unit to perform operations comprising:
executing the first trigger at a first schedule and with first priority.

6. The device of claim 1, wherein the instructions are configured to cause the processing unit to perform operations comprising:
receiving, from the controller device and through the network interface, new information for operating in one or more new states associated with collecting data; and
operating in a third state that is included in the one or more new states based on the new information.

7. The device of claim 6, wherein the instructions for receiving the new information for operating in one or more new states include instructions that are configured to cause the processing unit to perform operations comprising:
downloading, from the controller device and through the network interface, information corresponding to the one or more new states;
saving the information corresponding to the one or more new states;
executing the information corresponding to the one or more new states; and
operating in the third state in response to executing the information corresponding to the one or more new states.

8. The device of claim 6, wherein the instructions for receiving the new information for operating in one or more new states include instructions that are configured to cause the processing unit to perform operations comprising:
retrieving, from memory coupled to the device, information corresponding to the one or more new states that is saved in the memory;
executing the information corresponding to the one or more new states; and
operating in the third state in response to executing the information corresponding to the one or more new states.

9. A device comprising:
a processing unit;
a network interface configured to enable communications with sensor devices in a network; and
a machine-readable medium storing instructions that are executable by the processing unit, and when executed configured to cause the processing unit to perform operations comprising:
sending, using the network interface and to a sensor device in the network, information for operating in one or more states that include information for collecting data from a first sensor coupled to the sensor device;
receiving, from the sensor device, sensor data collected by the sensor device from the first sensor;
examining the sensor data received from the sensor device; and
in response to examining the sensor data received from the sensor device, sending, to the sensor device, new information for operating in one or more new states that include information for collecting data from a second sensor coupled to the sensor device, wherein the second sensor is configured to collect data of a different type than data collected by the first sensor.

10. The device of claim 9, wherein the instructions for sending the new information for operating in one or more new states include instructions that are configured to cause the processing unit to perform operations comprising:
generating the new information for operating in one or more new states based on examining the sensor data received from the sensor device.

11. The device of claim 10, wherein the instructions for generating the new information for operating in one or more new states include instructions that are configured to cause the processing unit to perform operations comprising:
generating the new information for operating in one or more new states based on examining sensor data received previously, wherein the sensor data received previously is stored in memory coupled to the device.

12. The device of claim 9, wherein the sensor data collected by the sensor device from the first sensor include sensor data collected at a first sampling rate, and
wherein the new information for operating in one or more new states include information for collecting data from the first sensor at a second sampling rate that is different from the first sampling rate.

13. A system comprising:
a sensor device including a machine-readable medium storing first instructions that are executable by a first processing unit, and when executed configured to cause the first processing unit to perform operations comprising:
receiving, using a network interface coupled to the sensor device and from a controller device through a controller device in a network, information for operating in one or more states associated with collecting data;
operating in a first state based on the information, wherein operating in the first state includes operations comprising:
controlling a first sensor coupled to the sensor device for collecting first sensor data at a first sampling rate;
executing a first trigger;
determining an output of the first trigger, wherein the output of the first trigger is based on the first sensor data; and
based on the output of the first trigger, determining whether to remain in the first state, or switch to a different state.

14. The system of claim 13, wherein the first instructions are configured to cause the first processing unit to perform operations comprising:
determining that the output of the first trigger includes a first value;
in response to determining that the output of the first trigger includes a first value, switching to a second state, wherein switching to the second state is based on the information received from the controller device; and
operating in the second state, which includes controlling a second sensor coupled to the sensor device for collecting second sensor data, the second sensor being configured to collect data of a different type than data collected by the first sensor, the second sensor data being different from the first sensor data.

15. The system of claim 13, wherein the first instructions are configured to cause the first processing unit to perform operations comprising:
determining that the output of the first trigger includes a second value; and
in response to determining that the output of the first trigger includes a second value and based on the information received from the controller device, operating in the first state, including performing operations comprising controlling the first sensor for collecting first sensor data at a second sampling rate that is different from the first sampling rate.

16. The system of claim 15, wherein the first instructions are configured to cause the processing unit to perform first operations comprising:
executing a second trigger while operating in the first state;
determining that an output of the second trigger includes a first value, wherein the output of the second trigger is based on the first sensor data;
in response to determining that the output of the second trigger includes the first value and based on the information received from the controller device, switching to a second state; and
operating in the second state, which includes controlling a second sensor coupled to the sensor device for collecting second sensor data, the second sensor being configured to collect data of a different type than data collected by the first sensor, the second sensor data being different from the first sensor data.

17. The system of claim 13, wherein the first instructions are configured to cause the first processing unit to perform operations comprising:
receiving, from the controller device and through the network interface, new information for operating in one or more new states associated with collecting data; and
operating in a third state that is included in the one or more new states based on the new information.

18. The system of claim 17, wherein the first instructions for receiving the new information for operating in one or more new states include first instructions that are configured to cause the first processing unit to perform operations comprising:
downloading, from the controller device and through the network interface, information corresponding to the one or more new states;
saving the information corresponding to the one or more new states;
executing the information corresponding to the one or more new states; and
operating in the third state in response to executing the information corresponding to the one or more new states.

19. The system of claim 17, wherein the first instructions for receiving the new information for operating in one or more new states include first instructions that are configured to cause the first processing unit to perform operations comprising:
retrieving, from memory coupled to the sensor device, information corresponding to the one or more new states that is saved in the memory;
executing the information corresponding to the one or more new states; and
operating in the third state in response to executing the information corresponding to the one or more new states.

20. The system of claim 13, comprising:
the controller device including a machine-readable medium storing second instructions that are executable by a second processing unit, and when executed configured to cause the second processing unit to perform operations comprising:
sending, using a network interface coupled to the controller device and to the sensor device, information for operating in one or more states that include information for collecting data from a first sensor coupled to the sensor device;
receiving, from the sensor device, sensor data collected by the sensor device from the first sensor;
examining the sensor data received from the sensor device; and
in response to examining the sensor data received from the sensor device, sending, to the sensor device, new information for operating in one or more new states that include information for collecting data from a second sensor coupled to the sensor device, wherein the second sensor is configured to collect data of a different type than data collected by the first sensor.

21. The system of claim 20, wherein the second instructions for sending the new information for operating in one or more new states include second instructions that are configured to cause the second processing unit to perform operations comprising:
generating the new information for operating in one or more new states based on examining the sensor data received from the sensor device.

22. The system of claim 21, wherein the second instructions for generating the new information for operating in one or more new states include second instructions that are configured to cause the second processing unit to perform operations comprising:
generating the new information for operating in one or more new states based on examining sensor data received previously, wherein the sensor data received previously is stored in memory coupled to the controller device.

23. The system of claim 20, wherein the sensor data collected by the sensor device from the first sensor include sensor data collected at the first sampling rate, and
wherein the new information for operating in one or more new states include information for collecting data from the first sensor at a second sampling rate that is different from the first sampling rate.

24. A method comprising:
receiving, at a sensor device and from a controller device in a network, information for operating in one or more states associated with collecting data, wherein the receiving comprises receiving through a network interface coupled to the sensor device;
performing operations, by the sensor device, in a first state based on the information, wherein the operations in the first state include operations comprising:
controlling a first sensor coupled to the sensor device for collecting first sensor data at a first sampling rate;
executing a first trigger;
determining an output of the first trigger, wherein the output of the first trigger is based on the first sensor data; and
based on the output of the first trigger, determining whether to remain in the first state, or switch to a different state.

25. The method of claim 24, comprising:
determining, by the sensor device, that the output of the first trigger includes a first value;
in response to determining that the output of the first trigger includes a first value, switching to a second state by the sensor device, wherein switching to the second state is based on the information received from the controller device; and
performing operations, by the sensor device, in the second state, which includes controlling a second sensor coupled to the sensor device for collecting second sensor data, the second sensor being configured to collect data of a different type than data collected by the first sensor, the second sensor data being different from the first sensor data.

26. The method of claim 24, comprising:
determining, by the sensor device, that the output of the first trigger includes a second value; and
in response to determining that the output of the first trigger includes a second value and based on the information received from the controller device, performing operations, by the sensor device, in the first state, including controlling the first sensor for collecting first sensor data at a second sampling rate that is different from the first sampling rate.

27. The method of claim 26, comprising:
executing, by the sensor device, a second trigger while operating in the first state;
determining, by the sensor device, that an output of the second trigger includes a first value, wherein the output of the second trigger is based on the first sensor data;
in response to determining that the output of the second trigger includes the first value and based on the information received from the controller device, switching to a second state by the sensor device; and
performing operations, by the sensor device, in the second state, which includes controlling a second sensor coupled to the sensor device for collecting second sensor data, the second sensor being configured to collect data of a different type than data collected by the first sensor, the second sensor data being different from the first sensor data.

28. The method of claim 24, comprising:
executing the first trigger at a first schedule and with first priority.

29. The method of claim 24, comprising:
receiving, at the sensor device and from the controller device, new information for operating in one or more new states associated with collecting data; and
performing operations, by the sensor device, in a third state that is included in the one or more new states based on the new information.

30. The method of claim 29, wherein receiving the new information for operating in one or more new states comprises:
downloading, by the sensor device through the network interface and from the controller device, information corresponding to the one or more new states;
saving, by the sensor device, the information corresponding to the one or more new states;
executing, by the sensor device, the information corresponding to the one or more new states; and
performing operations, by the sensor device, in the third state in response to executing the information corresponding to the one or more new states.

31. The method of claim 29, wherein receiving the new information for operating in one or more new states comprises:
retrieving, by the sensor device and from memory coupled to the sensor device, information corresponding to the one or more new states that is saved in the memory;
executing, by the sensor device, the information corresponding to the one or more new states; and
operating, by the sensor device, in the third state in response to executing the information corresponding to the one or more new states.

32. The method of claim 24, comprising:
sending, by the controller device and to the sensor device, information for operating in one or more states that include information for collecting data from a first sensor coupled to the sensor device, wherein the sending comprises sending through a network interface coupled to the controller device;
receiving, at the controller device and from the sensor device, sensor data collected by the sensor device from the first sensor;
examining, by the controller device, the sensor data received from the sensor device; and
in response to examining the sensor data received from the sensor device, sending, by the controller device and to the sensor device, new information for operating in one or more new states that include information for collecting data from a second sensor coupled to the sensor device, wherein the second sensor is configured to collect data of a different type than data collected by the first sensor.

33. The method of claim 32, wherein sending the new information for operating in one or more new states comprises:
generating, by the controller device, the new information for operating in one or more new states based on examining the sensor data received from the sensor device.

34. The method of claim 33, wherein generating the new information for operating in one or more new states comprises:
generating, by the controller device, the new information for operating in one or more new states based on examining sensor data received previously, wherein the sensor data received previously is stored in memory coupled to the controller device.

35. The method of claim 32, wherein the sensor data collected by the sensor device from the first sensor include sensor data collected at a first sampling rate, and
wherein the new information for operating in one or more new states include information for collecting data from the first sensor at a second sampling rate that is different from the first sampling rate.
